(19) United States
(12) Patent Application Publication
(10) Pub. No.: US 2021/0213468 A1
(43) Pub. Date: Jul. 15, 2021

(54) DECORATIVE ROTATING LAWN SPRINKLER

(71) Applicant: James David Thompson, Newborn, GA (US)

(72) Inventor: James David Thompson, Newborn, GA (US)

(21) Appl. No.: 17/146,477

(22) Filed: Jan. 11, 2021

Related U.S. Application Data
(60) Provisional application No. 62/958,737, filed on Jan. 9, 2020.

(51) Int. Cl. B05B 3/02; B05B 3/04

(52) U.S. Cl. CPC B05B 3/021; B05B 3/0409

(57) ABSTRACT

Implementations of a decorative rotating lawn sprinkler are provided. In some implementations, the decorative rotating lawn sprinkler comprises a rotating sprinkler head, a figurine, piping, and a support.

In some implementations, an example method of use of the decorative rotating lawn sprinkler comprises anchoring or otherwise supporting the decorative rotating lawn sprinkler on a lawn or other surface, connecting the decorative rotating lawn sprinkler to a water source, and operating the decorative rotating lawn sprinkler to disperse water from the connected water source over a circular or semi-circular area of the lawn or other vegetation.

### CROSS REFERENCE TO RELATED APPLICATION

This application claims the benefit of U.S. Patent Application Ser. No. 62/958,737, which was filed on Jan. 9, 2020, and is incorporated herein by reference in its entirety.

### TECHNICAL FIELD

This disclosure relates to implementations of a decorative rotating lawn sprinkler.

### BACKGROUND

Rotating lawn sprinklers are used to automatically water lawns or other vegetation by spraying a stream of water over a circular or semi-circular area. However, as shown in FIG. 1, existing rotating lawn sprinklers have a strictly functional, non-decorative design and appearance that can be unappealing and undesirable for various locations, such as residential and some commercial lawns. Furthermore, existing rotating lawn sprinklers usually spray a stream of water instead of further dispersing the water.

### BRIEF DESCRIPTION OF THE DRAWINGS

FIG. 1 illustrates an example existing rotating lawn sprinkler.

FIGS. 2A-2D illustrate an implementation of an example decorative rotating lawn sprinkler according to the present disclosure.

### DETAILED DESCRIPTION

Implementations of a decorative rotating lawn sprinkler are provided. In some implementations, the decorative rotating lawn sprinkler comprises a rotating sprinkler head, a figurine, piping, and a support.

In some implementations, the decorative rotating lawn sprinkler is configured to provide a rotating lawn sprinkler with a decorative appearance that at least partially conceals a rotating sprinkler head. In some implementations, the decorative rotating lawn sprinkler is configured to provide a rotating lawn sprinkler with a decorative appearance that substantially conceals a rotating sprinkler head.

In some implementations, the decorative rotating lawn sprinkler is configured to provide a rotating lawn sprinkler with a figurine or other decorative ornament that conceals a rotating sprinkler head.

In some implementations, the decorative rotating lawn sprinkler is configured to disperse water more than the usual stream from an existing rotating lawn sprinkler.

In some implementations, the decorative rotating lawn sprinkler is configured to disperse water over a circular or semi-circular area of a lawn or other vegetation.

In some implementations, an example method of operation of the decorative rotating lawn sprinkler comprises receiving water from a connected water source to the decorative rotating lawn sprinkler. In some implementations, the method comprises dispersing the water from the decorative rotating lawn sprinkler over a circular or semi-circular area of a lawn or other vegetation.

In some implementations, an example method of use of the decorative rotating lawn sprinkler comprises anchoring and/or otherwise supporting the decorative rotating lawn sprinkler on a lawn or other surface. In some implementations, the method comprises connecting the decorative rotating lawn sprinkler to a water source. In some implementations, the method comprises operating the decorative rotating lawn sprinkler to disperse water from the connected water source over a circular or semi-circular area of the lawn or other vegetation.

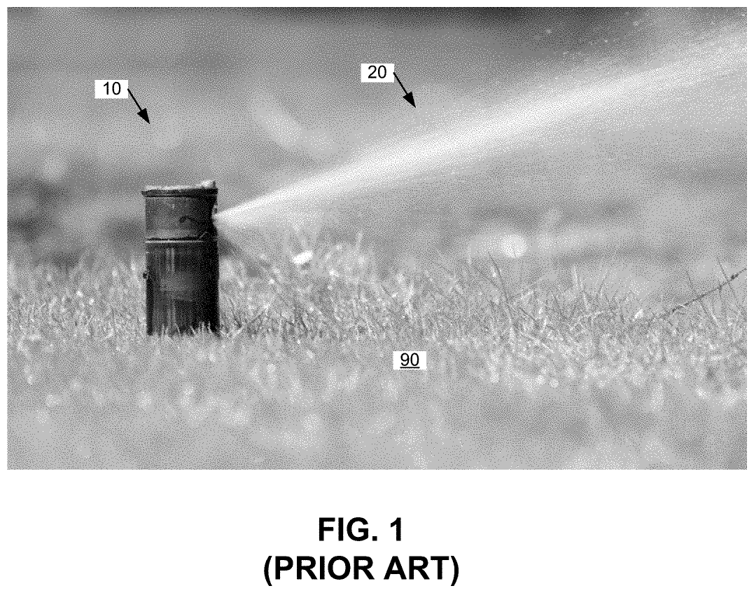

FIG. 1 illustrates an example existing rotating lawn sprinkler 10. Rotating lawn sprinklers 10 are used to automatically water lawns 90 or other vegetation by spraying a stream 20 of water over a circular or semi-circular area. However, as shown in FIG. 1, existing rotating lawn sprinklers 10 have a strictly functional, non-decorative design and appearance that can be unappealing and undesirable for various locations, such as residential and some commercial lawns 90. Furthermore, existing rotating lawn sprinklers 10 usually spray a stream 20 of water instead of further dispersing the water.

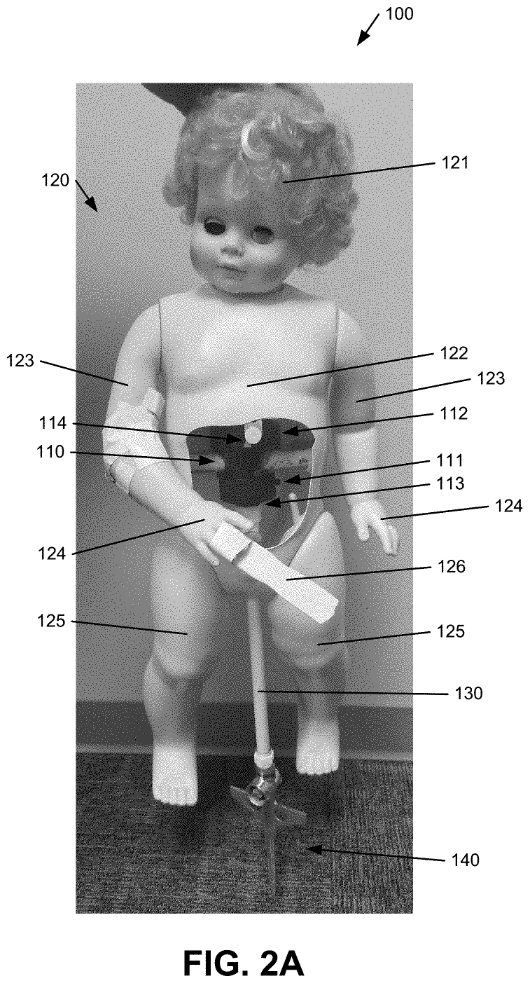

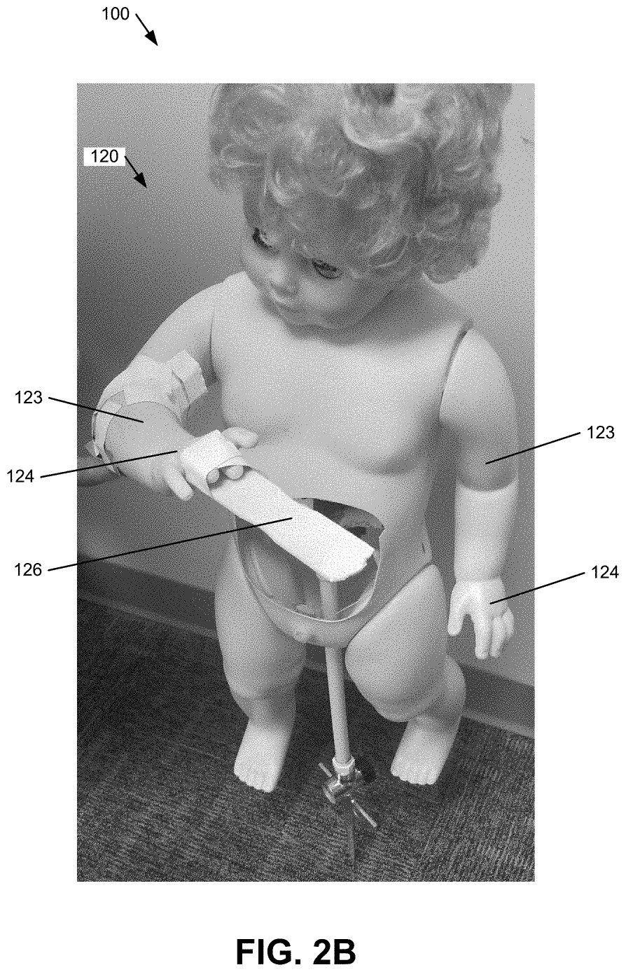

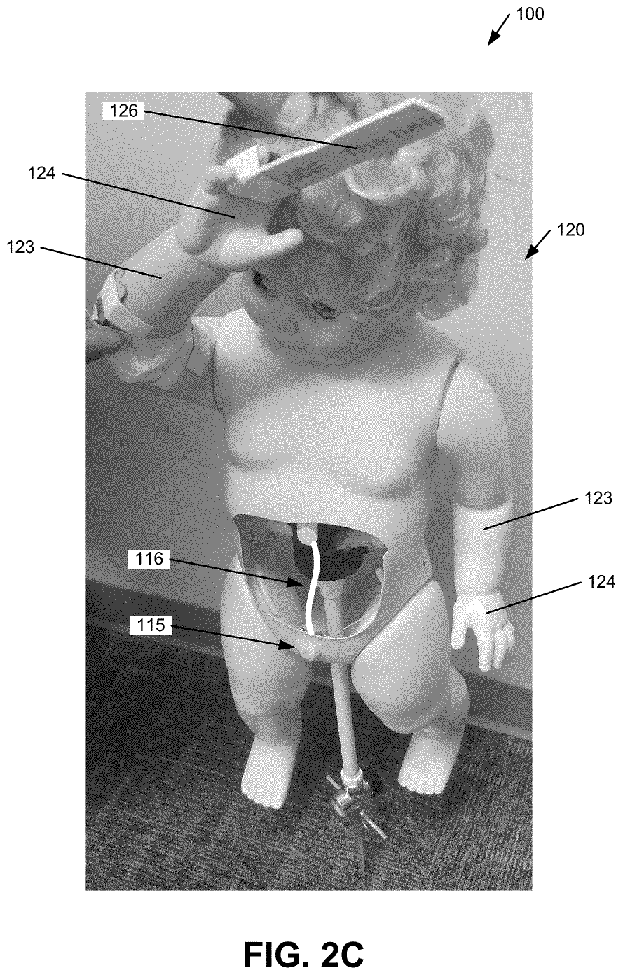

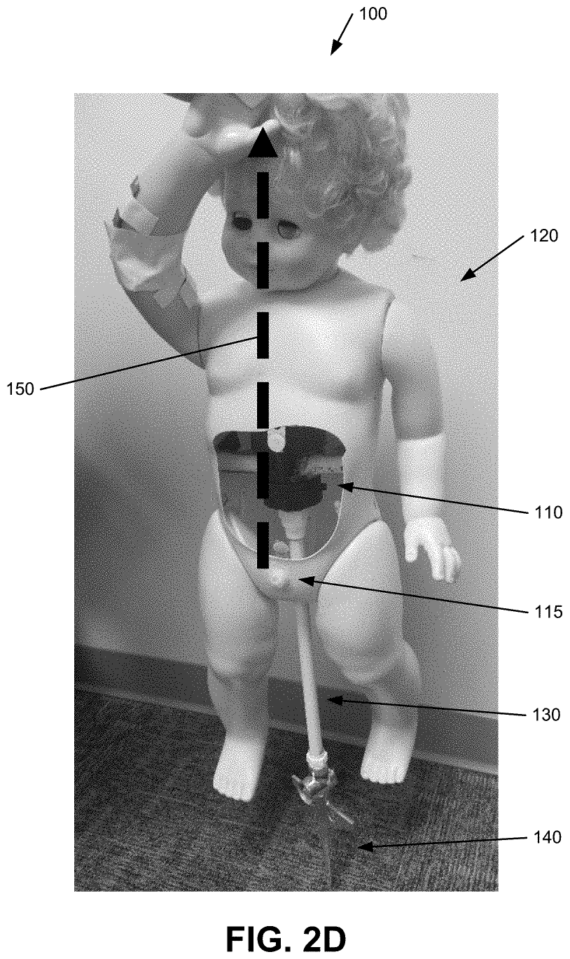

FIGS. 2A-2D illustrate an implementation of an example decorative rotating lawn sprinkler 100 according to the present disclosure. In some implementations, the decorative rotating lawn sprinkler 100 comprises a rotating sprinkler head 110, a figurine 120, piping 130, and a support 140.

As shown in FIG. 2A, in some implementations, the rotating sprinkler head 110 may comprise any suitable rotating sprinkler head, mechanism, assembly, etc. that comprises the features described herein. For example, in some implementations, the rotating sprinkler head 110 may be the same or similar to a rotating lawn sprinkler, such as the rotating lawn sprinkler 10 described above for FIG. 1. However, as described herein, in some implementations, the decorative rotating lawn sprinkler 100 comprises other/additional features.

As shown in FIG. 2A, in some implementations, the rotating sprinkler head 110 comprises a non-moving/stationary portion 111, a moving/rotating portion 112, a water input 113, and a water output 114. In some implementations, the water input 113 is connected and/or integrated to the stationary portion 111. In some implementations, the water output 114 is connected and/or integrated to the rotating portion 112.

As shown in FIG. 2C, in some implementations, the rotating sprinkler head 110 may further comprise a water output extension 115.

As shown in FIG. 2A, in some implementations, the rotating sprinkler head 110 is connected to the figurine 120 and to the piping 130, which are described below. For example, in some implementations, the rotating portion 112 of the rotating sprinkler head 110 is connected to the figurine 120. In some implementations, the water input 113 of the rotating sprinkler head 110 is connected to the piping 130. In some implementations, the rotating sprinkler head 110 may be connected to the figurine 120 and to the piping 130 in any other suitable configuration.

In some implementations, the rotating portion 112 is connected to the figurine 120 such that the figurine is moved/rotated when the rotating portion 112 moves/rotates.

In some implementations, the water input 113 is connected to the piping 130 such that the rotating sprinkler head 110 can receive water from the piping 130 to release through the water output 114.

In some implementations, the water output extension 115 may comprise tubing 116 or any other suitable component(s) that can carry water from the water output 114 to the water output extension 115 on the figurine 120. As shown in FIG. 2C, in some implementations, the water output extension 115 may be connected to the water output 114 by the tubing 116 to extend the water output 114 to a position on the figurine 120, such as an anatomical area of the figurine 120, as described below.

In some implementations, the water output extension 115 may be configured to extend the water output 114 to a position on the figurine 120. In some implementations, the water output extension 115 may be configured to extend the water output 114 to any other suitable position on the decorative rotating lawn sprinkler 100 in any other suitable configuration.

In some implementations, the rotating sprinkler head 110 is configured to receive water through the water input 113. In some implementations, the rotating sprinkler head 110 is configured to release the water through the water output 114. In some implementations, the rotating portion 112 of the rotating sprinkler head 110 is configured to rotate or semi-rotate as the rotating sprinkler head 110 releases the water through the water output 114. In this way, in some implementations, the rotating sprinkler head 110 is configured to release water over a circular or semi-circular area in a rotating or semi-rotating (e.g., reciprocating) manner, such as similar to the operation of a rotating sprinkler head (such as the above-described rotating lawn sprinkler 10).

As shown in FIG. 2A, in some implementations, the figurine 120 may comprise a doll or similar figure. For example, in some implementations, the figurine 120 may comprise the figure of a person, such as a baby boy, that includes a head 121, body 122, arms 123, hands 124, legs 125, etc.

In some implementations, the figurine 120 may comprise a decorative ornament in the form of a human wherein the decorative ornament comprises an outer surface enclosing a hollow interior, a movable arm 123, and an opening 115 through the outer surface into the interior wherein the opening 115 is located in the groin area of the human form.

In some implementations, the figurine 120 may comprise any other suitable statuesque, ornamental, decorative, etc. component(s) that provide the features described herein.

As shown in FIG. 2A, in some implementations, the figurine 120 may comprise a baffle or extension 126 extending from the hand(s) 124.

In some implementations, the figurine 120 is configured to encase or otherwise house or enclose the rotating sprinkler head 110. For example, as shown in FIG. 2A, in some implementations, the figurine 120 is configured to contain the rotating sprinkler head 110 in the body 122 of the figurine 120.

In some implementations, the figurine 120 is configured to house the rotating sprinkler head 110 such that the rotating sprinkler head 110 is held in a certain position. For example, in some implementations, the figurine 120 is configured to house the rotating sprinkler head 110 such that the rotating sprinkler head 110 is positioned to dispense water from an area of the figurine 120 that is similar to the anatomical area from which a person would urinate (e.g., at or adjacent to the groin area). That is, in some implementations, the figurine 120 is configured to house the rotating sprinkler head 110 such that the water output 114 of the rotating sprinkler head 110 positions at or adjacent to such anatomical area of the figurine 120.

As shown in FIG. 2C, in some implementations, the water output 114 may be extended to such anatomical area of the figurine 120 by the water output extension (or anatomical area output) 115 of the rotating sprinkler head 110, described above.

In some implementations, the figurine 120 may be configured to contain the rotating sprinkler head 110 in any other suitable configuration. In some implementations, the figurine 120 may be configured to hold the rotating sprinkler head 110 in any other suitable position.

As shown in FIG. 2A, in some implementations, the figurine 120 is configured to connect (or attach) to the rotating sprinkler head 110. In some implementations, the figurine 120 is configured to connect to the rotating sprinkler head 110 such that the figurine 120 moves/rotates when the rotating sprinkler head 110 moves/rotates, such as in the manner described above. For example, in some implementations, the figurine 120 is configured to connect to the rotating portion 112 of the rotating sprinkler head 110 such that the figurine 120 moves/rotates in such manner.

As shown in FIGS. 2A-2D, in some implementations, the figurine 120 is configured such that the force 150 from water released from the rotating sprinkler head 110 causes at least one of the arms 123 and/or respective hands 124 of the figurine 120 to raise and lower. For example, as shown in FIG. 2D, in some implementations, the figurine 120 is configured such that the arm(s) 123 and/or respective hand(s) 124 raises and lowers from the force/flow 150 of water dispensed from the anatomical area output 115 against the arm(s) 123 and/or respective hand(s) 124 as the rotating sprinkler head 110 releases the water and also moves/rotates the figurine 120.

In some implementations, the figurine 120 is configured such that water released from the rotating sprinkler head 110 is dispersed instead of streamed. For example, as shown in FIG. 2D, in some implementations, the figurine 120 is configured such that water is dispersed by at least one of the hands 124 of the figurine 120 as the water flow 150 is dispensed from the anatomical area output 115 against the hand(s) 124.

In some implementations, the figurine 120 is further configured such that water released from the rotating sprinkler head 110 is dispersed in the above-described manner by the water flow 150 against the extension(s) 126 extending from the hand(s) 124.

In some implementations, the figurine 120 is configured such that water released from the rotating sprinkler head 110 is more dispersed than the usual stream from an existing rotating lawn sprinkler, such as the above-described stream 20 for FIG. 1. In some implementations, the water is dispersed while at the same time the ornamental structure of the figurine 120 is moved in the way it would ordinarily move.

In some implementations, the figurine 120 is configured such that water dispensed from the opening 115 of the figurine 120 is dispersed by a surface 126 (and/or the hand 124) of the figurine 120 such that the width of the stream of the water dispersed by the surface 126 (and/or the hand 124) of the figurine 120 is wider than the width of the stream of the water dispensed from the opening 115 of the figurine 120.

In some implementations, the figurine 120 is configured to provide a decorative appearance to the decorative rotating lawn sprinkler 100. In some implementations, the figurine 120 is configured to at least partially conceal the rotating sprinkler head 110 with a decorative appearance.

In some implementations, the figurine 120 is configured to substantially conceal the rotating sprinkler head 110 with a decorative appearance. In some implementations, the figurine 120 is configured to provide any other suitable appearance to the decorative rotating lawn sprinkler 100.

As shown in FIG. 2A, in some implementations, the piping 130 comprises one or more pipes or tubing. In some implementations, the piping 130 may comprise any other suitable component(s) that can deliver water to the rotating sprinkler head 110.

As shown in FIG. 2A, in some implementations, the piping 130 is connected to the water input 113 of the rotating sprinkler head 110. For example, in some implementations, one end of the piping 130 is connected to the water input 113. In some implementations, the other end of the piping 130 is connected to a water source (not shown), such as a water pipe.

As shown in FIG. 2A, in some implementations, the piping 130 may also be connected to the support 140 of the decorative rotating lawn sprinkler 100, described below. In some implementations, the piping 130 may be connected to the rotating sprinkler head 110 and the support 140 such that the piping 130 supports one or more components of the decorative rotating lawn sprinkler 100, such as the rotating sprinkler head 110 and the figurine 120, in an upright or otherwise standing position.

In some implementations, the piping 130 is configured to carry water to the rotating sprinkler head 110 from a connection to a water source. In some implementations, the piping 130 is configured to connect to the water input 113 of the rotating sprinkler head 110.

In some implementations, the piping 130 may also be configured to connect to the support 140. In some implementations, the piping 130 may be configured to support one or more components of the decorative rotating lawn sprinkler 100, such as the rotating sprinkler head 110 and the figurine 120, in an upright or otherwise standing position.

As shown in FIG. 2A, in some implementations, the support 140 comprises a stake or similar component. In some implementations, the support 140 may alternately comprise a weighted base.

In some implementations, the support 140 may further comprise a stand or frame. In some implementations, the support 140 may comprise any other suitable component(s) that can support and/or anchor one or more components of the decorative rotating lawn sprinkler 100, such as the rotating sprinkler head 110 and the figurine 120, to a lawn (such as the lawn 90 shown in FIG. 1) or other suitable surface.

In some implementations, the support 140 is configured to support and/or anchor one or more components of the decorative rotating lawn sprinkler 100, such as the rotating sprinkler head 110 and the figurine 120, to a lawn or other suitable surface. In some implementations, the support 140 is configured to support and/or anchor the decorative rotating lawn sprinkler 100 in an upright or otherwise standing position.

In some implementations, the support 140 may also be configured to support and/or anchor the piping 130 of the decorative rotating lawn sprinkler 100.

In some implementations, the support 140 is configured to connect to one or more components of the decorative rotating lawn sprinkler 100, such as the rotating sprinkler head 110, the figurine 120, and/or the piping 130.

In some implementations, the support 140 may be configured to provide any other suitable support for the decorative rotating lawn sprinkler 100.

In some implementations, the decorative rotating lawn sprinkler 100 is configured to provide a rotating lawn sprinkler with a decorative appearance that at least partially conceals a rotating sprinkler head 110. In some implementations, the decorative rotating lawn sprinkler 100 is configured to provide a rotating lawn sprinkler with a decorative appearance that substantially conceals a rotating sprinkler head 110.

In some implementations, the decorative rotating lawn sprinkler 100 is configured to provide a rotating lawn sprinkler with a figurine 120 or other decorative ornament that conceals a rotating sprinkler head 110.

In some implementations, the decorative rotating lawn sprinkler 100 is configured to disperse water more than the usual stream 20 from an existing rotating lawn sprinkler 10 (e.g., as described above).

In some implementations, the decorative rotating lawn sprinkler 100 is configured to disperse water over a circular or semi-circular area of a lawn 90 or other vegetation.

In some implementations, the decorative rotating lawn sprinkler 100 comprises any suitable dimensions.

In some implementations, the decorative rotating lawn sprinkler 100 is composed of any suitable materials.

In some implementations, the decorative rotating lawn sprinkler 100 can have any suitable appearance, such as the above-described decorative appearance.

In some implementations, an example method of operation of the decorative rotating lawn sprinkler 100, with respect to the above-described figures, comprises the piping 130 receiving water from a connected water source. In some implementations, the method comprises the piping 130 delivering the water to the water input 113. In some implementations, the method comprises dispersing the water from the rotating sprinkler head 110 through the water output 114 over a circular or semi-circular area of a lawn 90 or other vegetation.

In some implementations, the rotating sprinkler head 110 is decoratively concealed by the attached figurine 120, which is moved/rotated by the rotating sprinkler head 110 as it releases the water.

In some implementations, the water output 114 is positioned at or adjacent to an anatomical/groin area of the figurine 120 (as described above). In some implementations, the water output 114 is extended to the anatomical area of the figurine 120 by the water output extension 115 of the rotating sprinkler head 110.

In some implementations, the water from the rotating sprinkler head 110 is dispersed by the figurine 120, such as by water flow 150 from the anatomical output 115 against a hand 124 of the figurine 120 (as described above). In some implementations, the water is dispersed from the decorative rotating lawn sprinkler 100 more than the usual stream 20 from an existing rotating lawn sprinkler 10.

In some implementations, an arm 123 and/or the respective hand 124 of the figurine 120 is raised and lowered by the force of the water flow 150 from the anatomical output 115 against the arm 123 and/or the respective hand 124 (as described above) while the decorative rotating lawn sprinkler 100 rotates and disperses the water.

In some implementations, an example method of use of the decorative rotating lawn sprinkler 100, with respect to the above-described FIGS. 2A-2C, comprises anchoring and/or otherwise supporting the decorative rotating lawn sprinkler 100 by the support 140 on a lawn 90 or other suitable surface. In some implementations, the method comprises connecting the decorative rotating lawn sprinkler 100 to a water source by the piping 130. In some implementations, the method comprises operating the decorative rotating lawn sprinkler 100 to disperse water from the connected water source over a circular or semi-circular area of the lawn 90 or other vegetation according to the above-described method of operation.

The figures, including photographs and drawings, comprised herewith may represent one or more implementations of the decorative rotating lawn sprinkler.

Details shown in the figures, such as dimensions, descriptions, etc., are exemplary, and there may be implementations of other suitable details according to the present disclosure.

Reference throughout this specification to “an embodiment” or “implementation” or words of similar import means that a particular described feature, structure, or characteristic is comprised in at least one embodiment of the present invention. Thus, the phrase “in some implementations” or a phrase of similar import in various places throughout this specification does not necessarily refer to the same embodiment.

Many modifications and other embodiments of the inventions set forth herein will come to mind to one skilled in the art to which these inventions pertain having the benefit of the teachings presented in the foregoing descriptions and the associated drawings.

The described features, structures, or characteristics may be combined in any suitable manner in one or more embodiments. In the above description, numerous specific details are provided for a thorough understanding of embodiments of the invention. One skilled in the relevant art will recognize, however, that embodiments of the invention can be practiced without one or more of the specific details, or with other methods, components, materials, etc. In other instances, well-known structures, materials, or operations may not be shown or described in detail.

While operations may be depicted in the drawings in a particular order, this should not be understood as requiring that such operations be performed in the particular order shown or in sequential order, or that all illustrated operations be performed, to achieve desirable results.

1. A decorative rotating lawn sprinkler comprising:
a rotating lawn sprinkler head having an opening for dispensing water; and
a decorative ornament in the form of a human wherein the decorative ornament comprises an outer surface enclosing a hollow interior, a movable arm, and an opening through the outer surface into the interior wherein the opening is located in the groin area of the human form, wherein:
the rotating lawn sprinkler head is positioned within the hollow interior of the decorative ornament;
the decorative ornament is operatively attached to the rotating lawn sprinkler head such that the decorative ornament rotates along with the rotating lawn sprinkler head;
the decorative rotating lawn sprinkler is configured such that water dispensed from the opening of the rotating lawn sprinkler head also dispenses from the opening located in the groin area of the decorative ornament such that the decorative ornament appears to be urinating;
the decorative rotating lawn sprinkler is configured such that the movable arm raises and lowers by the water dispensed from the opening of the decorative ornament; and
the decorative rotating lawn sprinkler is configured such that the water dispensed from the opening of the decorative ornament is dispersed by a surface of the decorative ornament.

2. The decorative rotating lawn sprinkler of claim 1 wherein the decorative rotating lawn sprinkler is configured such that the water is dispensed from the opening of the decorative ornament and against the hand of the decorative ornament such that movable arm raises and lowers as the rotating lawn sprinkler head operates.

3. The decorative rotating lawn sprinkler of claim 1 wherein the decorative ornament is in the form of a male toddler.

4. The decorative rotating lawn sprinkler of claim 1 wherein the opening of the rotating lawn sprinkler head is positioned in line with the opening of the decorative ornament such that water dispensed from the opening of the rotating lawn sprinkler head also dispenses from the opening of the decorative ornament such that the decorative ornament appears to be urinating.

5. The decorative rotating lawn sprinkler of claim 1 further comprising a water tubing connected between the opening of the rotating lawn sprinkler head and the opening of the decorative ornament, wherein the water tubing is connected such that water dispensed from the opening of the rotating lawn sprinkler head also dispenses from the opening of the decorative ornament such that the decorative ornament appears to be urinating.

6. The decorative rotating lawn sprinkler of claim 1 wherein the water dispensed from the opening of the decorative ornament is dispersed by a surface of the decorative ornament such that the width of the stream of the water dispersed by the surface of the decorative ornament is wider than the width of the stream of the water dispensed from the opening of the decorative ornament.

7. The decorative rotating lawn sprinkler of claim 1 further comprising a support configured to support the decorative rotating lawn sprinkler on a surface in a position such that the decorative rotating lawn sprinkler disperses water onto the surface.

8. The decorative rotating lawn sprinkler of claim 7 wherein the support comprises a stake.

9. The decorative rotating lawn sprinkler of claim 7 wherein the support comprises a weighted base.

10. A method of using the decorative rotating lawn sprinkler of claim 1 comprising providing water to the rotating lawn sprinkler head from a water source thereby causing the decorative rotating lawn sprinkler to dispense the water from the opening of the rotating lawn sprinkler head and the opening of the decorative ornament such that the decorative ornament appears to be urinating and the movable arm raises and lowers as the rotating lawn sprinkler head operates.

11. The method of claim 10 further comprising providing the water to the rotating lawn sprinkler head from the water source thereby causing the decorative rotating lawn sprinkler to dispense the water from the opening of the rotating lawn sprinkler head and the opening of the decorative ornament such that the water dispensed from the opening of the decorative ornament is dispersed by the surface of the decorative ornament.

12. The method of claim 11 wherein the water dispensed from the opening of the decorative ornament is dispersed by a surface of the decorative ornament such that the width of the stream of the water dispersed by the surface of the decorative ornament is wider than the width of the stream of the water dispensed from the opening of the decorative ornament.

13. A method of using the decorative rotating lawn sprinkler of claim 7 comprising:
positioning the decorative rotating lawn sprinkler on a surface by the support; and
providing water to the rotating lawn sprinkler head from a water source thereby causing the decorative rotating lawn sprinkler to dispense the water from the opening of the rotating lawn sprinkler head and the opening of the decorative ornament such that the decorative ornament appears to be urinating and the movable arm raises and lowers as the rotating lawn sprinkler head operates.

14. The method of claim 13 further comprising providing the water to the rotating lawn sprinkler head from the water source thereby causing the decorative rotating lawn sprinkler to dispense the water from the opening of the rotating lawn sprinkler head and the opening of the decorative ornament such that the water dispensed from the opening of the decorative ornament is dispersed by the surface of the decorative ornament.

15. The method of claim 14 wherein the water dispensed from the opening of the decorative ornament is dispersed by a surface of the decorative ornament such that the width of the stream of the water dispersed by the surface of the decorative ornament is wider than the width of the stream of the water dispensed from the opening of the decorative ornament.
